(19) United States
(12) Patent Application Publication
(10) Pub. No.: US 2026/0088429 A1
(43) Pub. Date: Mar. 26, 2026

(54) Case for Batteries

(71) Applicant: Cacharricos, S.L., Barcelona (ES)

(72) Inventor: Leonardo Dolgan Vergas Hernandez, Barcelona (ES)

(21) Appl. No.: 19/334,220

(22) Filed: Sep. 19, 2025

(30) Foreign Application Priority Data
Sep. 20, 2024 (EP) 24383007.2

(51) Int. Cl. H01M 50/264; H01M 50/213; H01M 50/258

(52) U.S. Cl. CPC H01M 50/264; H01M 50/213; H01M 50/258

(57) ABSTRACT

The case (1) for batteries comprises a plurality of housings (2) for said batteries; a closed base (3) placed on a first end (4) of the case (1) for contacting with the batteries when they are in said housings (2); an opening (5) placed at a second end (6) opposite from the first end (4) for the insertion and removal of the batteries from the housings (2); at least one first magnet (7) placed at the first end (4) of the case (1) for detachably retaining the batteries inside the housings (2); and at least one second magnet (8) placed at the second end (6) of the case (1) for detachably attaching an adjacent case (1). It permits to provide a case for batteries, that permit to detachably join two or more cases in a modular way, so that the storage and transportation of the batteries is enhanced.

### CROSS-REFERENCE TO RELATED APPLICATION AND PRIORITY

The present application claims priority under 35 U.S.C. § 119(a) to European Application No. 24383007.2, filed on Sep. 20, 2024, which is expressly incorporated herein by reference in its entirety.

### TECHNICAL FIELD AND BACKGROUND

The present invention relates to a case for batteries, comprising means for detachably attaching two or more cases to each other in a modular way.

Some activities require the use of a great number of batteries, that must be stored and transported to the site of use.

One of these activities is related with the audiovisual production, including the task of sound technician. This activity requires the use of batteries with the electrical devices usually used.

Due to the power that these electrical devices require, the batteries must be changed after a short period of time. Therefore, the person in charge must have access to a plurality of charged batteries

In the market are available cases for batteries, comprising a plurality of housings, each housing a battery. One of the problems of these known cases is how to retain the batteries inside their housings permitting an easy insertion and removal.

To solve this problem, it is known the use of magnets for retaining the batteries inside the housings, so that the batteries can be removed from the case by hand pushing them against the force exerted by the magnets.

These cases can include several housings, such as four, six, twelve or even more, so that the user must have different cases with different capacities of batteries, and these cases do not comprise any attaching means for making them modular.

Therefore, an objective of the present invention is to provide a case for batteries, that permit to detachably join two or more cases in a modular way, so that the storage and transportation of the batteries is enhanced.

The case for batteries of the invention solves the above-mentioned disadvantages and has other advantages which will be described below.

### SUMMARY

The disclosed case for batteries according to the present invention as described and claimed includes additional features that are optional.

In particular, the case for batteries comprises a plurality of housings for said batteries, a closed base placed on a first end of the case for contacting with the batteries when they are in said housings, and an opening placed at a second end opposite from the first end for the insertion and removal of the batteries from the housings. The case further includes at least one first magnet placed at the first end of the case for detachably retaining the batteries inside the housings and at least one second magnet placed at the second end of the case for detachably attaching an adjacent case.

Thanks to the second magnet(s), the case according to the present invention can be detachably attached to one or more adjacent cases in a very simple way, forming a modular case assembly, permitting the storage and transportation of a great number of batteries in one single module.

Preferably, a plurality of second magnets is placed at the second end of the case, at opposite sides of the at least one opening.

Furthermore, a plurality of first magnets is preferably placed at the first end of the case, one first magnet for each housing.

For permitting the easy removal of the batteries, each housing comprises a pair of lateral windows, so that the batteries can be pushed through said lateral windows.

According to a preferred embodiment, each second magnet is placed at the second end between two adjacent housings.

### BRIEF DESCRIPTION OF THE DRAWINGS

For a better understanding of what has been explained above, some drawings are included in which, schematically and only by way of a non-limiting example, a practical case of embodiment is represented.

FIG. 1 is a frontal elevation view of the case for batteries according to the present invention.

FIG. 2 is a side elevation view of the case for batteries according to the present invention

FIG. 3 is a side elevation view of two cases according to the present invention attached to each other.

FIG. 4 is a side elevation view of four cases according to the present invention attached to each other.

### DETAILED DESCRIPTION

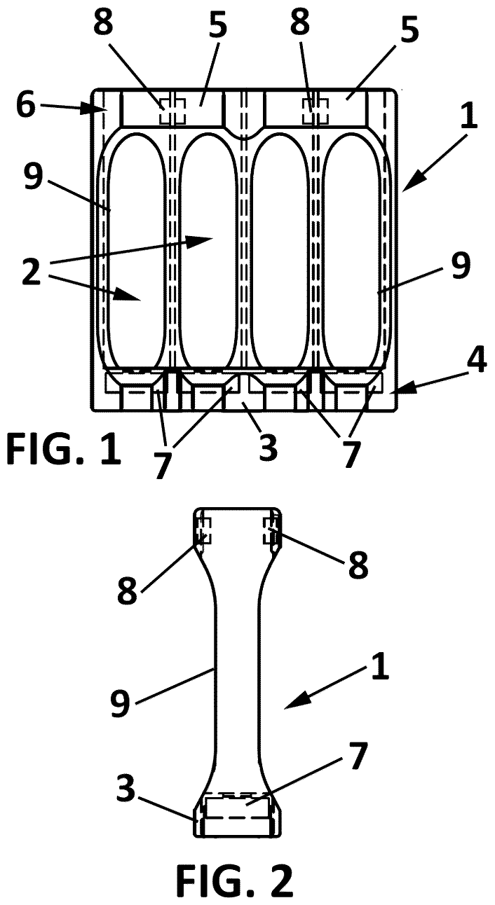

FIG. 1 shows a frontal elevation view of the case (1) for batteries according to the present invention. This case (1) comprises a plurality of housings (2) where one battery can be placed inside each housing (2). The case (1) also comprises a closed base (3) placed on a first end (4) of the case (1), so that when a battery is placed inside a housing (2), the battery contacts this base (3). At a second end (6) opposite from the first end (4) of the case (1) the is an opening (5) for the insertion and removal of the batteries from the housings (2).

The case (1) according to the present invention also comprises at least one first magnet (7) placed at the first end (4) of the case (1) for detachably retaining the batteries inside the housings (2). Therefore, when a battery is inserted in any of the housings (2), the or one first magnet (7) retains the battery inside the housing (2).

According to the embodiment shown in FIGS. 1 and 2, a plurality of first magnets (7) is placed at the first end (4) of the case (1), one first magnet (7) for each housing (2). For removing the battery from the housing (2), each housing (2) comprises lateral windows (9), so that the user can push the battery with one finger to said opening (5), displacing the battery from the first magnet (7), so that the magnetic force does not act on the battery.

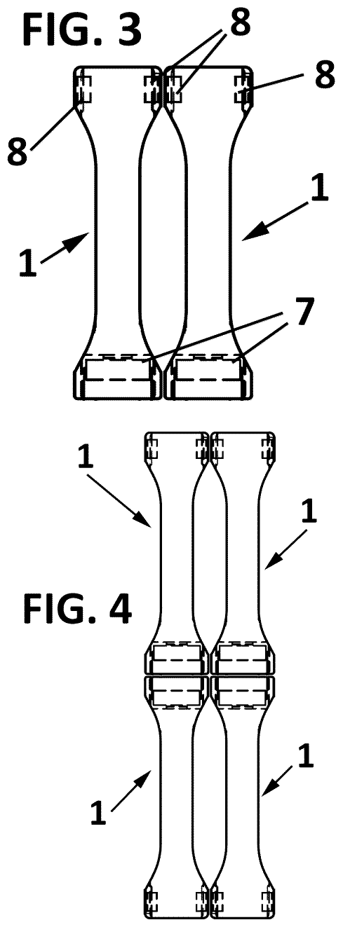

Furthermore, the case (1) according to the present invention also comprises at least one second magnet (8) placed at the second end (6) of the case (1). This at least one second magnet (8) is for detachably attaching an adjacent case (1), i.e. for making a module formed by two or more cases (1), as shown in FIGS. 3 and 4.

According to the embodiment shown in FIG. 2, the case (1) comprises a plurality of second magnets (8) placed at the second end (6) of the case (1), at opposite sides of the at least one opening (5), so that an adjacent case (1) can be attached at each side of the case (1). According to this embodiment, and as shown in FIG. 2, each second magnet (8) is placed at the second end (6) between two adjacent housings (2).

In FIG. 3 a module comprising two cases (1) is shown and in FIG. 4 a module comprising four cases (1) is shown. However, it must be pointed out that a module with any suitable number of cases (1) can be formed. Furthermore, it must be clarified that the at least one magnet (7) is also used for detachably attaching an adjacent case (1), so that two adjacent cases (1) are attached by their bases (3).

Thanks to the presence of these magnets, two or more cases (1) can are attached to each other, forming a module that can be stored and transported easily, and that can be detached also easily when the user wants to remove and use the batteries.

Although reference has been made to a specific embodiment of the invention, it is obvious to a person skilled in the art that the case for batteries described is susceptible to numerous variations and modifications, and that all the details mentioned can be replaced by technically equivalent ones, without departing from the scope of protection defined by the appended claims.

What is claimed is:

1. A case for batteries comprising:
a plurality of housings for the batteries;
a closed base placed on a first end of the case for contacting with the batteries when the batteries are in the plurality of housings;
an opening placed at a second end opposite from the first end for the insertion and removal of the batteries from the plurality of housings; and
at least one first magnet placed at the first end of the case for detachably retaining the batteries inside the plurality of housings; and
at least one second magnet placed at the second end of the case, wherein the at least one second magnet is attracted to an adjacent magnet integrated with an adjacent case, thereby detachably attaching the adjacent case.

2. A case for batteries according to claim 1, wherein a plurality of second magnets is placed at the second end of the case, at a opposite side of the at least one opening.

3. A case for batteries according to claim 1, wherein a plurality of first magnets is placed at the first end of the case, and wherein the plurality of first magnets comprises one first magnet for each housing.

4. A case for batteries according to claim 1, wherein the plurality of housings comprises a pair of lateral windows.

5. A case for batteries according to claim 2, wherein each second magnet is placed at the second end between two adjacent housings.

6. A case for batteries according to claim 1, wherein a plurality of first magnets is placed at the first end of the case, and wherein the plurality of first magnets comprises one first magnet for each housing.

7. A modular battery storage apparatus comprising:
a first case comprising
a first end;
a first retaining magnet integrated with the first end;
a first connector battery magnet integrated with a second end;
a first sidewall extending from the first end to the second end; and
a second sidewall extending from the first end to the second end, wherein
the first end, the second end, the first sidewall, and the second sidewall define an elongated hollow first housing sized to accommodate a plurality of batteries, a first battery disposed within the first housing, and
wherein the first retaining magnet imposes an attractive force on the first battery;
a second case comprising
a third end;
a second retaining magnet integrated with the third end;
a second connector battery magnet integrated with a fourth end;
a third sidewall extending from the third end to the fourth end; and
a fourth sidewall extending from the third end to the fourth end, wherein
the third end, the fourth end, the third sidewall, and the fourth sidewall define an elongated hollow second housing sized to accommodate a plurality of batteries, and
a second battery disposed within the second housing,
wherein the second retaining magnet imposes an attractive force on the second battery; and
wherein the first case is coupled to the second case by an attractive magnetic force between the first connector battery magnet and the second connector battery magnet.

8. A modular battery storage apparatus according to claim 7, wherein the first battery and second battery comprise a “AA” battery or a “AAA” battery.

9. A modular battery storage apparatus according to claim 7, wherein the first battery and second battery are cylindrical.

10. A modular battery storage apparatus according to claim 7, wherein the first housing and second housing further comprise a plurality of lateral windows.

11. A modular battery storage apparatus according to claim 10, wherein when a user pushes on the first battery through one of the plurality of lateral windows the attractive magnetic force of the first battery is disrupted and wherein the first battery becomes separated from the case, and when the user pushes on the second battery through one of the plurality of lateral windows the attractive magnetic force of the second battery is disrupted and wherein the second battery is separated from the case.

12. A modular battery storage apparatus according to claim 7, wherein an additional case may be coupled to the first case or second case by an attractive magnetic force.
